(19) United States
(12) Patent Application Publication
(10) Pub. No.: US 2007/0276911 A1
(43) Pub. Date: Nov. 29, 2007

(54) Method and System for Transferring Contact Information and Calendar Events to a Wireless Device Via E-Mail

(76) Inventors: Soujanya Bhumkar, Palo Alto, CA (US); Ramiro Calvo, Palo Alto, CA (US); John B. Geagan III, State College, PA (US); Christian Goddy, New York, NY (US); Kenneth S. Thom, Palo Alto, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/564,018

(22) PCT Filed: Aug. 22, 2003
(86) PCT No.: PCT/US03/26381

§ 371 Date: Aug. 3, 2007

(30) Foreign Application Priority Data
Jul. 11, 2003 (US) PCT US03 21694

(51) Int. Cl. G06F 15/16

(52) U.S. Cl. 709/206

(57) ABSTRACT

A method and system for transferring contact information and calendar events (FIG. 1, 131) to a wireless device (FIG. 1,141) via e-mail (FIG. 9) are described. In one embodiment, the method comprises providing for one or more contacts (FIG. 10) to be included in an e-mail message (FIG. 14,1412) addressed to a unique e-mail address (FIG. 15,1522). The e-mail message is received at a server (FIG. 1,161) associated with the unique e-mail address. The one or more contacts are extracted from the e-mail message (FIG. 15,1524). A wireless device to send the one or more contacts to (FIG. 1,141) is determined by extracting delivery data contained in the e-mail message (FIG. 15,1512). One or more messages formatted specifically for the wireless device are generated (FIG. 9), wherein the one or more messages contain the one or more contacts (FIG. 10). The server checks if the wireless device is registered with the server (FIG. 15,1522); and sends the one or more messages to the wireless device if the wireless device is registered with the server (FIG. 15,1524).

This application is a continuation-in-part of and claims priority to PCT Application No. US03/21694, filed on Jul. 11, 2003.

### FIELD OF THE INVENTION

The present invention relates to and departs from the conventional practice of a generalized method for transferring contacts and calendar events between a personal computer or other Web-enabled device connected to the internet and a mobile phone. More particularly, the present transfer method provides a simple method to transfer contacts and calendar events to a wireless device using email. Additionally, text messages can be sent from a wireless device to a unique number so that the text message is either saved or sent to an email address.

### BACKGROUND OF THE INVENTION

Cell phone usage has reached the point where the majority of people in developed nations own one. Many phones produced today support a format for exchanging contact information known as a vcard (for “virtual business card”). The most common example of how vcards are used is for one person to send his personal contact information from his phone to somebody else's phone either via infrared or through the wireless network. The receiver's phone alerts her that a contact has been received and offers the choice to view, save, or discard the contact.

When a person sends a vcard through an operator's network, the vcard is transmitted from one phone to the other as a specially coded SMS. A vcard is transmitted as an SMS with a special tag at the beginning that alerts the phone that the SMS should be treated as a vcard. It should be noted that in many cases, the vcard is formatted in a vendor-specific manner, limiting the exchange of vcards only between like make and models of phones.

Before the vcard is ever sent as a contact to another phone, the contact information must first be saved in the sender's phone. A number of methods exist for storing contacts in phones, the most common of which is to manually key in the name and number using the phone keypad. Because this method is so tedious, it has limited the number of contacts people are willing to store on their phones.

The present invention offers a method to easily transfer contacts between a Web-based service and an SMS-enabled phone, thru an SMS-enabled network. One of the basic tasks for a cell phone user is to enter frequently dialed numbers into his or her phone via one of the following methods:

The most commonly used method is to manually key in each name and number via the phone keypad. This is simple for a small number of contacts but becomes very time-consuming and inefficient for any significant number of contacts.

Another method to enter contacts into a phone is to upload information from a PC via either a serial cable connection, infrared or Bluetooth. Each of these methods requires that the subscriber owns a PC with the appropriate interface and purchases and installs the appropriate software on the PC. This is expensive, complex and is not supported by all phones.

A newer method for storing contacts in a phone is based on the syncML and GPRS industry standards. This solution works well if the user has a phone that supports both syncML and GPRS, and uses a network operator that offers GPRS services. Currently, this solution is relatively expensive and available to a small segment of the market.

GSM phone users can store user-entered contact information on the SIM card in their phone. A user can then transfer all information to another phone simply by transferring the SIM card. Unfortunately, the contacts are lost if the subscriber loses his phone with the SIM card inside. Additionally, the SIM card has a limit of approximately 250 contacts, whereas newer phone models can store many hundreds of contacts, thus the SIM card cannot archive the full contact listing stored in the phone. Finally, many phones have the ability to store multiple phone numbers per name, which SIM cards are unable to do.

### SUMMARY OF THE INVENTION

A Method and System for Transferring contact Information and calendar events to a wireless device via e-mail are described. In one embodiment, the method comprises providing for one or more contacts and/or calendar events to be included in an e-mail message addressed to a unique e-mail address. The e-mail message is received at a server associated with the unique e-mail address. The one or more contacts and/or calendar events are extracted from the e-mail message. A wireless device to send the one or more contacts and/or calendar events to is determined by extracting delivery data contained in the e-mail message. One or more messages formatted specifically for the wireless device are generated, wherein the one or more messages contain the one or more contacts and/or calendar events. The server checks if the wireless device is registered with the server; and sends the one or more messages to the wireless device if the wireless device is registered with the server.

### BRIEF DESCRIPTION OF THE DRAWINGS

Features and advantages of the present invention will be apparent to one skilled in the art in light of the following detailed description in which:

FIG. 1 illustrates a block diagram of an exemplary system for transferring contact information to an SMS-enabled wireless device according to one embodiment of the present invention;

FIG. 2 illustrates an exemplary computer architecture according to one embodiment of the present invention;

FIG. 3 illustrates an SMS-enabled device such as a cellular telephone according to one embodiment of the present invention;

FIG. 4 illustrates an exemplary wireless device display for allowing a user to accept contacts, according to one embodiment of the present invention;

FIG. 5 illustrates an exemplary graphical user web-interface for allowing a user to login or begin to register with the system according to one embodiment of the present invention;

FIG. 6 illustrates an exemplary graphical user web-interface for allowing a user to enter registration information on the system, according to one embodiment of the present invention;

FIG. 7 illustrates an exemplary graphical user web-interface for displaying contact information on the system, according to one embodiment of the present invention;

FIG. 8 illustrates an exemplary graphical user web-interface for updating contact information on the system, according to one embodiment of the present invention;

FIG. 9 illustrates an exemplary graphical user web-interface for entering the phone number and/or e-mail address of a friend, according to one embodiment of the present invention;

FIG. 10 illustrates an exemplary graphical user web-interface for displaying incoming contact information on the system, according to one embodiment of the present invention;

FIG. 11 illustrates an exemplary graphical user web-interface for displaying business contact information on the system, according to one embodiment of the present invention;

FIG. 12 illustrates an exemplary graphical user web-interface for displaying system usage information, according to one embodiment of the present invention;

FIG. 13 illustrates an exemplary graphical user web-interface for editing profile information on the system, according to one embodiment of the present invention;

FIG. 14 illustrates an exemplary process for sending contacts from the web server to an SMS-enabled wireless device, according to one embodiment of the present invention;

FIG. 15 illustrates an exemplary process for sending contacts to additional SMS-enabled wireless devices, according to one embodiment of the present invention;

FIG. 16 illustrates an exemplary process for registering an SMS-enabled wireless device with the system, according to one embodiment of the present invention;

FIG. 17 illustrates an exemplary process for passing messages between an SMS-enabled wireless device and a web server, according to one embodiment of the present invention; and

FIG. 18 illustrates an exemplary process for sending contacts via e-mail to a wireless device or web inbox, according to one embodiment of the present invention.

### DETAILED DESCRIPTION

A method and system for transferring contact information and calendar events to a wireless device via e-mail are described. In one embodiment, the method comprises providing for one or more contacts to be included in an e-mail message addressed to a unique e-mail address. The e-mail message is received at a server associated with the unique e-mail address. The one or more contacts are extracted from the e-mail message. A wireless device, to send the one or more contacts to, is determined by extracting delivery data contained in the e-mail message. One or more messages formatted specifically for the wireless device are generated, wherein the one or more messages contain the one or more contacts. The server checks if the wireless device is registered with the server; and sends the one or more messages to the wireless device if the wireless device is registered with the server.

In the following description, for purposes of explanation, numerous specific details are set forth in order to provide a thorough understanding of the present invention. It will be evident, however, to one skilled in the art that the present invention may be practiced without these specific details. In some instances, well-known structures and devices are shown in block diagram form, rather than in detail, in order to avoid obscuring the present invention. These embodiments are described in sufficient detail to enable those skilled in the art to practice the invention, and it is to be understood that other embodiments may be utilized and that logical, mechanical, electrical, and other changes may be made without departing from the scope of the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention can be implemented by an apparatus for performing the operations herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network. The required structure for a variety of these systems will appear from the description below.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one skilled in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

Disclosed herein is a standard mechanism for owners of wireless devices that support vcards to store and retrieve their contact information between a Web site and the wireless device.

One embodiment of the present invention is an Internet- or intranet-based service that provides for the sharing of contacts by members who register to use the system; the contacts reside in a database which is dynamically generated based on the user's input. The system operates with a computer using a Windows, Macintosh, UNIX, Linux or other operating system equipped with a standard Web-browser application, or other Web-enabled device, capable of connecting to the Internet and/or a corporate Intranet. It should be noted that the term “Internet” is intended to encompass similar systems and nomenclature (i.e., World Wide Web or “www”) comprising the capability to communicate and access information through a network, telephone connections, ISDN connections, DSL connections, cable modem, fiber optic network, etc. The present invention should not be limited in its communication nomenclature; the present invention is applicable to any system that is accessible by means of a Web browser.

In one embodiment, the system is presented on a Web site, and the Web site provided by the invention is designed to enable users to enter contact information, upload contact information to the user's phone or to another person's phone, share contact information from a user's contact list with other people who may or may not be registered users of the system, view contacts sent to the user by other users, view Business contacts that may be of interest to the user, view usage information of contacts the user has uploaded to her phone, and make changes to the user's profile, such as changing a phone type or phone number.

An Exemplary Network Architecture

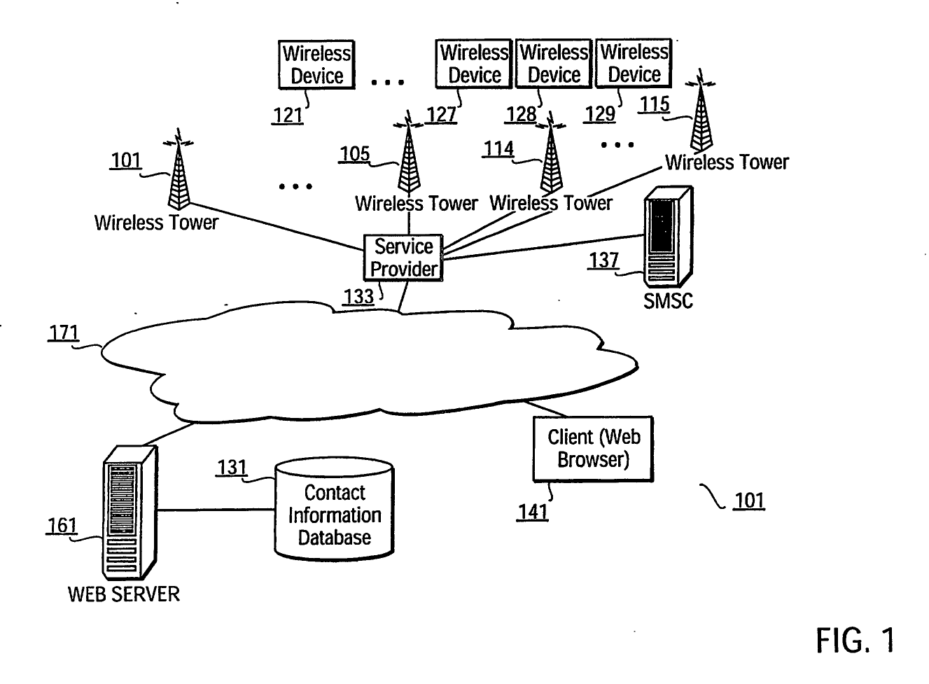

FIG. 1 illustrates a block diagram of an exemplary system for transferring contact information to an SMS-enabled wireless device. According to the embodiment depicted in FIG. 1, one or more wireless devices 121-129 are in proximity to wireless communication towers such as 101, 105, 111 and 115.

Wireless communication towers such as 101, 105, 111, and 115 transmit and receive data to and from wireless devices, which data is respectively received from and transmitted to Service Provider 133. Within some or all, wireless devices 121-129 are these wireless devices, such as, cellular telephones, two-way radios, or two-way pagers (e.g., in which the necessary transaction software is electronic in a microchip). Wireless devices such as global positioning satellite systems may also be carried within wireless devices 121-129, as well as, mobile personal computers and handheld computing devices. The SMS Center 137 (SMSC) processes all SMS messages received from the wireless devices 121-129 and the Web server 161. In one embodiment, the wireless device is a cellular telephone with an intelligent browser which communicates digitally over a wireless network to a traffic server using the radio hardware and infrastructure of the cellular service provider (e.g. SprintPCS™, AT&T™, etc . . . ).

In one embodiment, wireless devices may transmit and receive data from web server 161 over a variety of communication networks 171 including (but not limited to) a local area network (LAN) and/or a larger network (e.g., the Internet). Alternative communication channels such as wireless communication via satellite broadcast (not shown) are also contemplated within the scope of the present invention.

In general, the wired network side architecture of the present invention can be implemented as a standard telephone connection provided through an Internet service provider to enable data communication on the Internet over a conventional telephone network. This use of the Internet as a distribution network is well known to those of ordinary skill in the art. In an alternate embodiment having cable modem capability, communication over a conventional cable network is possible in lieu of communication over the telephone network. The cable network is typically much faster (i.e. provides a much greater bandwidth) than the standard telephone network; however, cable modems are typically more expensive than standard POTS (plain old telephone system) modems. In another alternate embodiment having conventional Integrated Services Digital Network (ISDN) capability, the network 171 is accessed by client 141 using an ISDN modem. Again, the ISDN network is typically faster than the POTS network; however, access to an ISDN network is generally more expensive. Cable modems and ISDN implementations are alternative communications media to the POTS implementation.

The wireless architecture of the present invention may be implemented using numerous types of networks. Examples of wireless networks upon within which the present invention may be implemented are Global System for Mobile Communications (GSM), Code Division Multiple Access (CDMA), Time Division Multiple Access (TDMA), Cellular Digital Packet Data (CDPD), Integrated Digital Enhanced Network (iDEN), etc.

Web server 161 sends and receives data from wireless devices. Web server 161 is connected to network 171. Wireless system 101 also includes contact information database 131. contact information database 131 stores information for all registered users including their e-mail address, wireless device phone numbers, contact names, and contact phone numbers. contact information database 131 is connected to Web server 161.

Web server 161 receives vcard type information from each wireless device. The information may be extracted from the wireless device using Wireless Markup Language (WML), or Hyper Text Markup Language (HTML) calls.

Web server 161 may internally store various types of data. This may include, for example, specific client data (e.g., client account information and client preferences) and/or more general data. The databases of system 101 in one embodiment run an instance of a Relational Database Management System (RDBMS), such as Microsoft™ SQL-Server, Oracle™ or the like. Although illustrated in FIG. 1 as separate databases, the data and functionality of database 131 may be combined within a single database, as well.

A mobile communication device may interact with and receive feedback from a web server 161 using various different communication devices and/or protocols, for example Wireless Application Protocol (WAP) or SMS. According to one embodiment, a mobile communication device connects to web server 161 via client software. The client software may include a browser application such as a WAP MicroBrowser in a cellular telephone, or Netscape Navigator™ or Microsoft Internet Explorer™ on a personal computer which communicates to web server 161 via the Hypertext Transport Protocol (hereinafter “HTTP”).

Note that any or all of the components of the system illustrated in FIG. 1 and associated hardware may be used in various embodiments of the present invention; however, it may be appreciated by those of ordinary skill in the art that other configurations of the system may be used within the spirit and scope of the present inventive method and system.

An Exemplary Computer Architecture

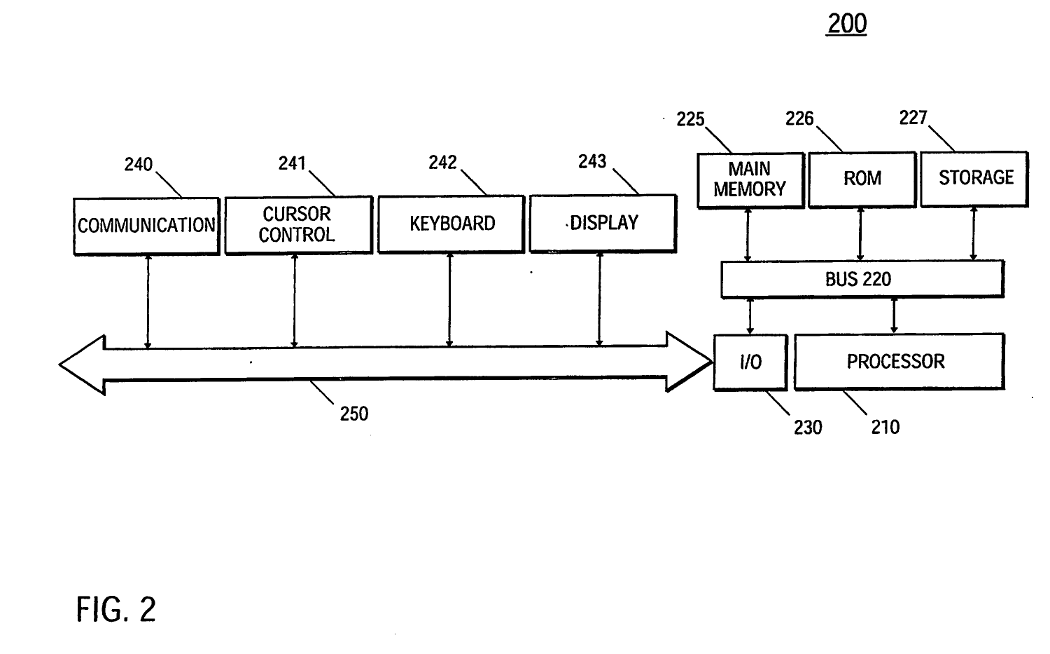

Having briefly described an exemplary network architecture which employs various elements of the present invention, a computer system 200 representing exemplary clients 141 and/or servers (e.g., web server 161), in which elements of the present invention may be implemented will now be described with reference to FIG. 2.

One embodiment of computer system 200 comprises a system bus 220 for communicating information, and a processor 210 coupled to bus 220 for processing information. Computer system 200 further comprises a random access memory (RAM) or other dynamic storage device 225 (referred to herein as main memory), coupled to bus 220 for storing information and instructions to be executed by processor 210. Main memory 225 also may be used for storing temporary variables or other intermediate information during execution of instructions by processor 210. Computer system 200 also may include a read only memory (ROM) and/or other static storage device 226 coupled to bus 220 for storing static information and instructions used by processor 210.

A data storage device 227 such as a magnetic disk or optical disc and its corresponding drive may also be coupled to computer system 200 for storing information and instructions. Computer system 200 can also be coupled to a second I/O bus 250 via an I/O interface 230. A plurality of I/O devices may be coupled to I/O bus 250, including a display device 243, an input device (e.g., an alphanumeric input device 242 and/or a cursor control device 241). For example, video news clips and related information may be presented to the user on the display device 243.

The communication device 240 is for accessing other computers (servers or clients) via a network 171. The communication device 240 may comprise a modem, a network interface card, or other well-known interface device, such as those used for coupling to Ethernet, token ring, or other types of networks.

An Exemplary Wireless Device Architecture

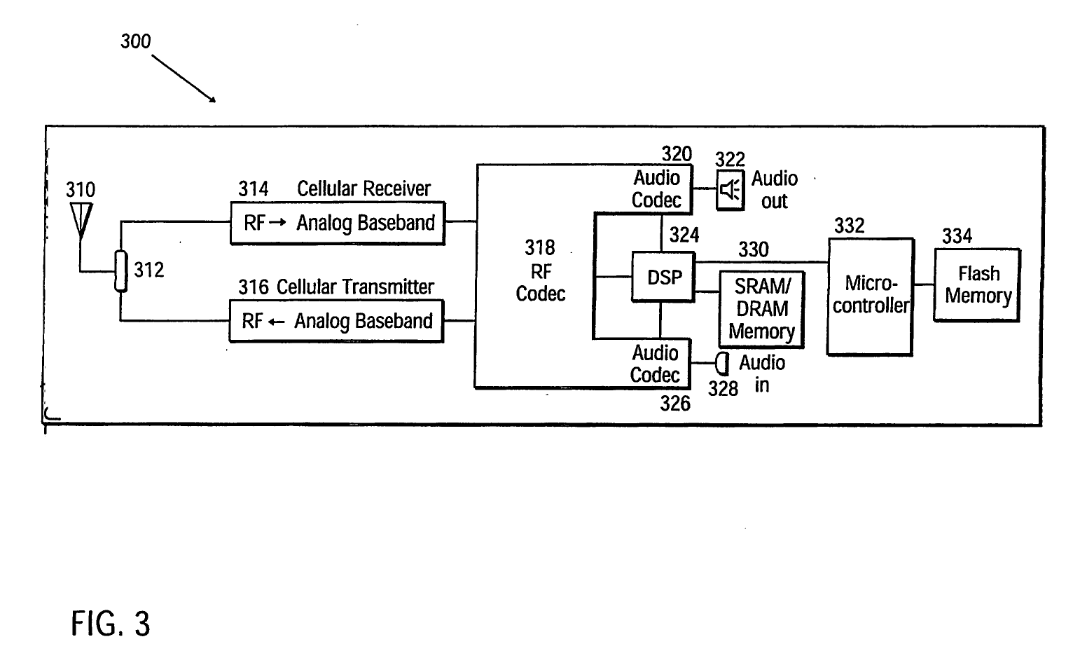

FIG. 3 illustrates an exemplary wireless device 300 such as an SMS-enabled cellular telephone according to one embodiment of the present invention. In the block diagram of wireless device 300, the wireless communication signal travels to and from the cellular telephone 300 via the antenna 310 and the signal is split at duplexer 312. If the cellular telephone is sending a communication, the data is either input by the user on the phone keypad (such as sending a contact via SMS) and relayed via the microcontroller 332, or the data is the user's voice spoken into the audio input microphone 328 on the phone and is encoded from an analog to digital signal by the audio codec 326. The respective data signal is then processed by the DSP 324 and encoded into a radio frequency (RF) signal by the the RF codec 318. The signal then passes through the cellular transmitter 316 to convert from the analog baseband signal to the appropriate cellular RF signal before sending it to the duplexer 312 and transmitting it out the antenna 310.

When the cellular telephone receives a communication, the incoming signal passes through the antenna 310 to the duplexer 312, which directs the signal to the cellular receiver 314 which converts from the cellular RF signal to the analog baseband signal. The RF codec 318 then decodes the signal and sends it to the DSP 324 which determines if it is data to be processed by the microcontroller 322 (such as a contact received that will be shown on the phone's display) or audio content to be decoded by the audio codec 320 and played through the phone's audio out speaker 322.

Additional components in the diagram include the SDRAM/DRAM memory 330, which stores data for use by the DSP and microcontroller only when the phone is powered on. The flash memory 334 contains data which is stored permanently whether the phone is powered on or off, such as contact and user profile information.

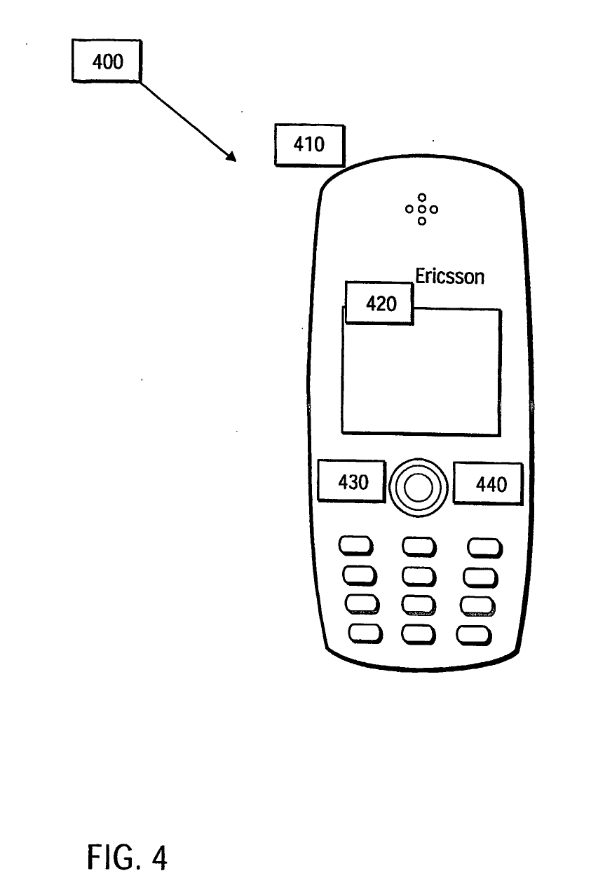

FIG. 4 illustrates an exemplary wireless device display for allowing a user to accept contacts, according to one embodiment of the present invention. The example 400 shows a standard cellular phone 410. The display 420 shows a simple query for the user to either add the received contact to the phone's address book or not. The user can add the received contact by pressing the Yes button 430, or can decline to add the contact by pressing the No button 440.

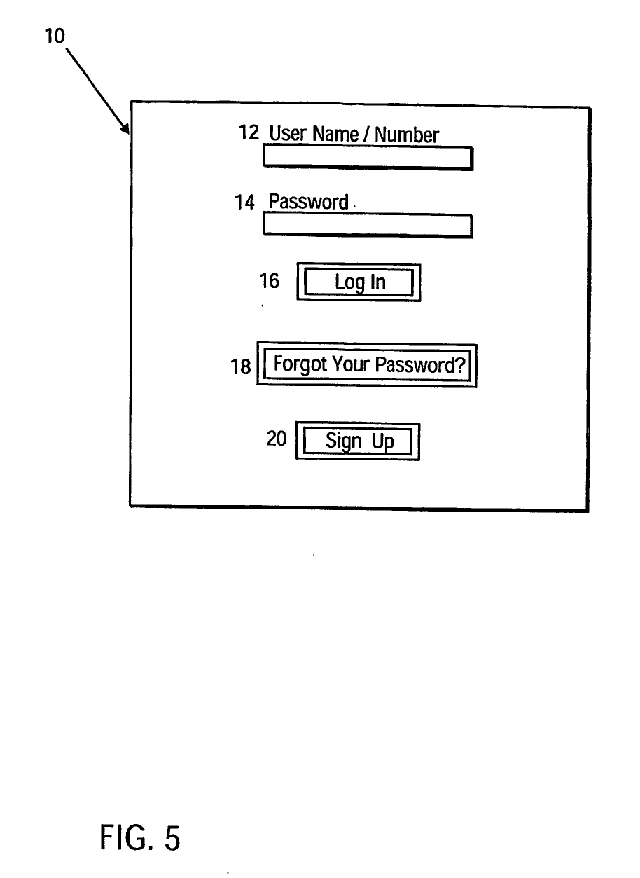

FIG. 5 illustrates an exemplary graphical user web-interface 10 for allowing a user to login or begin to register with the system according to one embodiment of the present invention. The web site's home page screen 10, such as displayed in FIG. 5, allows either a visitor to sign-up for the system by selecting the “Sign Up” button 12 or a registered user to log in to the system by entering User Name 14 and Password 16, then selecting the “Log In” button 18. If a registered user has forgotten his password, he can select the “Forgot Your Password” button 20 to be directed to a page where he must enter his mobile phone number to which the system will send an SMS with a new, temporary log in password.

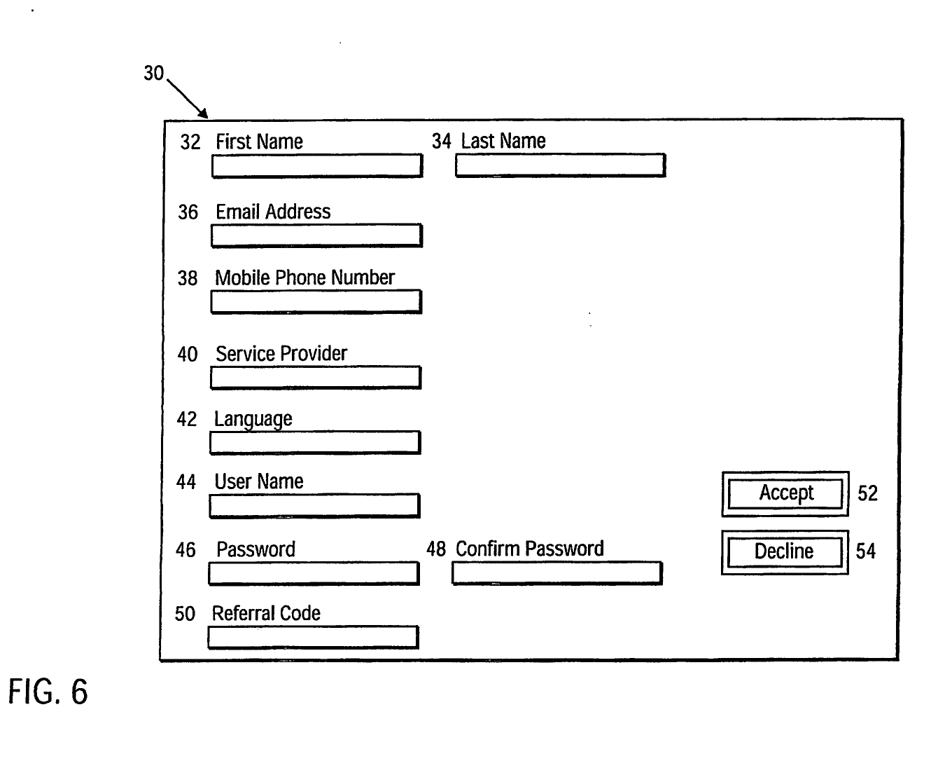

FIG. 6 illustrates an exemplary graphical user web-interface 30 for allowing a user to enter registration information on the system, according to one embodiment of the present invention. A registration page screen 30 which is presented to a visitor to the site who chooses to sign up for the system. The visitor must enter first name 32, last name 34, e-mail address 36, mobile phone number 38, service provider 40, language 42, user name 44, password 46, password confirmation 48 and referral code 50. The visitor then submits the registration information to the server by selecting the “Accept” button 52, or can choose not to sign up by hitting the “Decline” button 54. After choosing “Accept”, the user is presented with a screen that asks him to type the *#06# key sequence on his phone which causes GSM-based phones to display the phone's serial number on the phone screen. If the system does not recognize the Type Approval Code (TAC) contained within the serial number, or the user is unable to determine the phone type because, for example, she is not using a GSM-based phone, the system requests the user send a vcard to a specific phone number. The system is then able to determine the specific vcard format that is supported by that user's phone. This enables the system to subsequently upload contacts to the user's phone using the correct vcard format so that the user can view the contacts and save them on the phone.

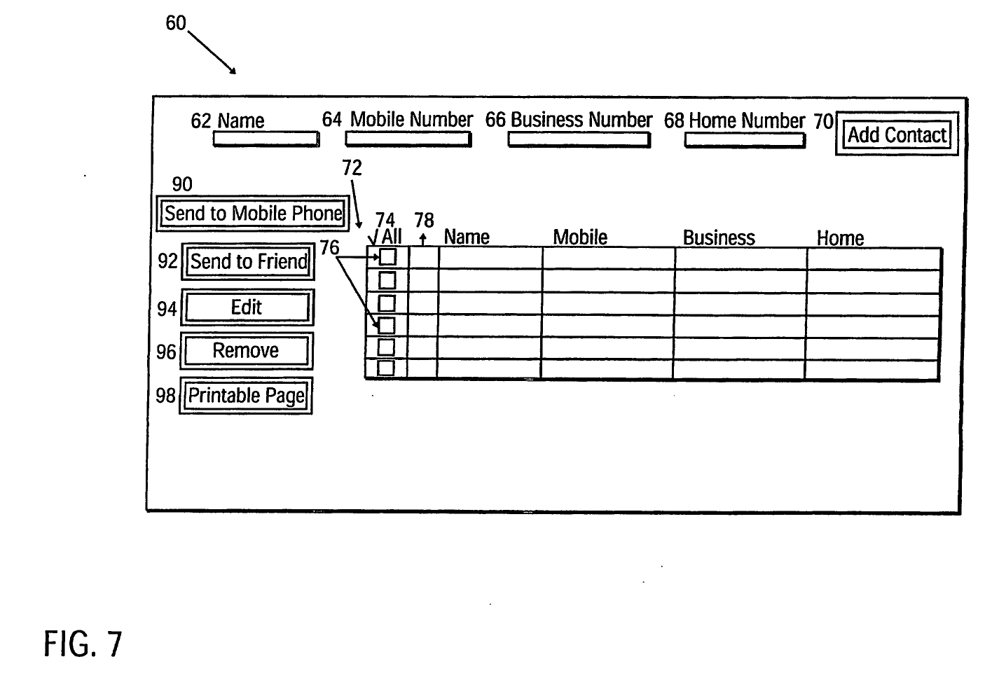

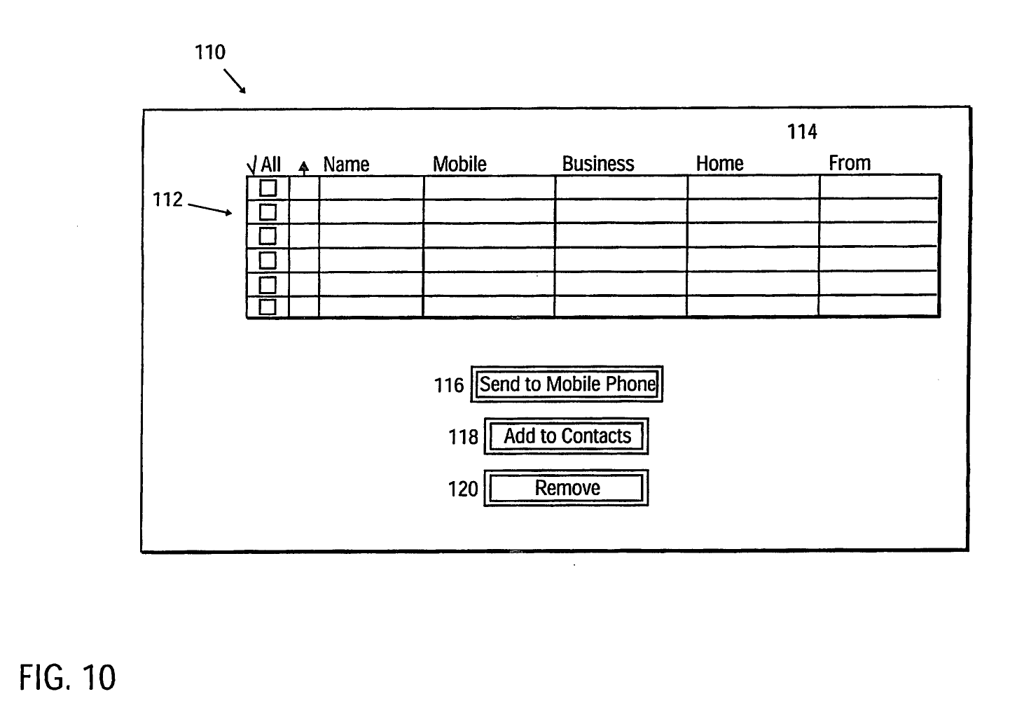

FIG. 7 illustrates an exemplary graphical user web-interface 60 for displaying contact information on the system, according to one embodiment of the present invention. A new user who has just completed registration is brought directly to a contacts page 60. contact page 60 is the central focus of the system, for this is where users first return each time they log back into the system, and where they enter contact information, upload contact information to their phones, send contacts to their friends and family and navigate to other pages of the Web site. A user adds contacts to the table 72 by entering a name 62 and one or more of the possible phone numbers: mobile 64, business 66, and home 68. The user can either hit the return button on the computer keyboard or select the “Add contact” button 70 to add the just-entered contact to the table. The table 72 displays all contacts that have been entered by the user and transferred from the user's Inbox (FIG. 10) and indicates which contacts have been uploaded to the phone by displaying the up-arrow indicator 78. Once the table contains some contacts, the user can take several actions using the buttons.

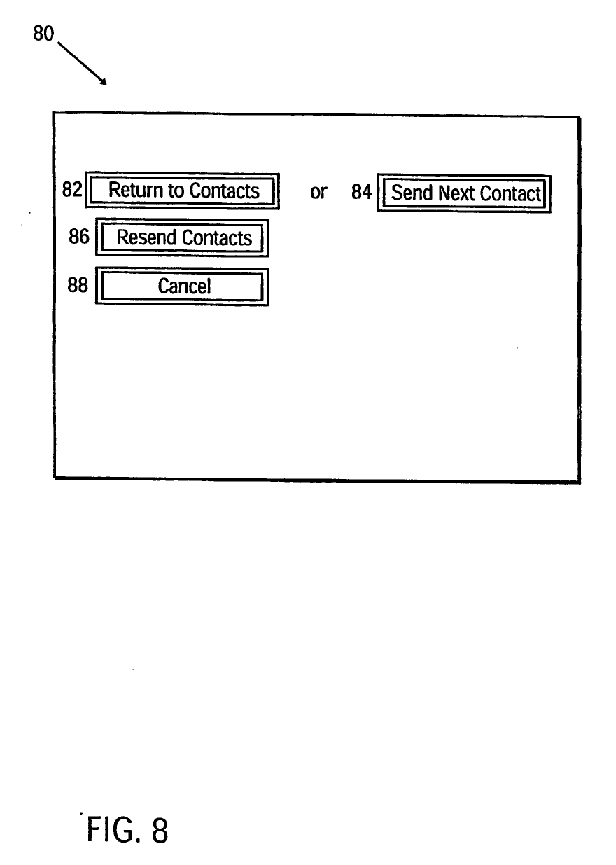

The user can click the “Send to Mobile Phone” button 90 to upload contacts to his mobile phone. If the user has not selected any contacts, the system will choose all contacts that have not yet been uploaded to the phone, as indicated by the up-arrow symbol in column 78, to be uploaded. Alternatively, the user can select any of the contacts by clicking on that contact's checkbox 76, or can select all of the contacts by clicking the Check-All button 74. If after selecting all the contacts the user would like to de-select all of the contacts, this is accomplished by again clicking the Check-All button 74. After the user clicks the “Send to Mobile Phone” button, the system sends one or more contacts to the phone, based on how many contacts were selected and how many contacts the phone's vcard buffer can accept. The user is then presented with an updated contacts screen 80 in FIG. 8.

FIG. 8 illustrates an exemplary graphical user web-interface 80 for updating contact information on the system, according to one embodiment of the present invention. contacts screen 80 will have either two or three buttons based on whether or not all the selected contacts could fit in the phone's vcard buffer. If all the contacts fit in the phone's buffer, the user can select the “Return to contacts” button 82 to go back to the full listing of contacts or the “Resend contact” button 86 to have the listed contacts resent if his phone did not receive all of the selected contacts. If all the contacts do not fit in the phone's vcard buffer, the system implements a pacing mechanism so that only as many contacts as can fit in the phone's vcard buffer are sent to the phone at one time. Subsequent contacts from the user's selection are sent only after the user has confirmed acceptance of the first set, then the user can select the “Send Next contact(s)” button 84 to send the next contact(s) to his phone, or the “Resend contact” button 86 if he did not receive all of the first set of the selected contacts on his phone, or the “Cancel” button 88 to cancel further sending of contacts and return to the full listing of contacts. The pacing mechanism is repeated until all of the contacts from the user's initial selection have been sent to the phone, or until the user cancels further sending of contacts.

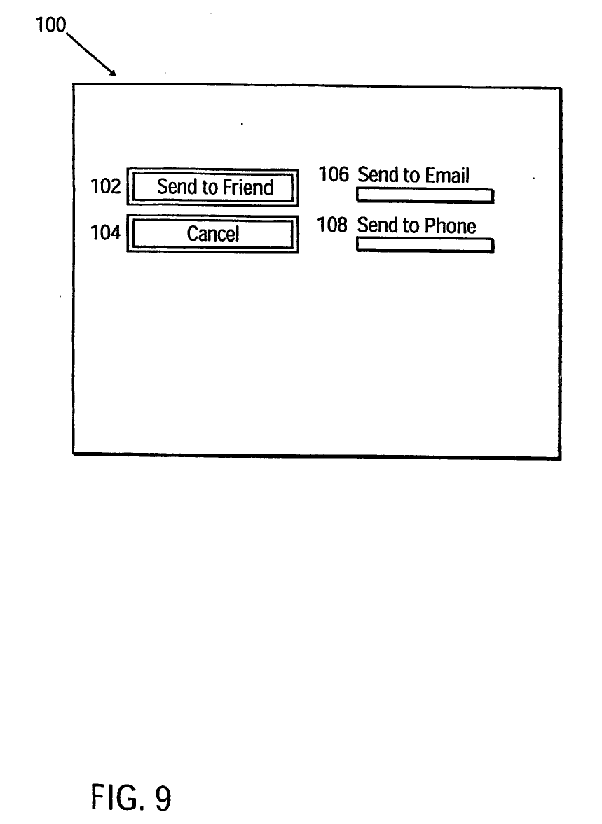

The user can click the “Send to Friend” button 92 in FIG. 7 to send one or more contacts from his list to another person who may or may not be a user of the system. If the user does not check any of the boxes 76, all the contacts in the list will be sent. The user can select any of the contacts to be sent by clicking on that contact's checkbox 76, or can select all of the contacts by clicking the Check-All button 74. If after selecting all the contacts the user would like to de-select all of the contacts, this is accomplished by again clicking the Check-All button 74. After the user clicks the “Send to Friend” button, the user is presented with a “Send to Friend” screen 100 in FIG. 9

FIG. 9 illustrates an exemplary graphical user web-interface 100 for entering the phone number and/or e-mail address of a friend, according to one embodiment of the present invention. The “Send to Friend” screen 100 has two buttons and two fields. The user can enter either an e-mail address in the “Send to E-mail” field 106 or a mobile phone number in the “Send to Phone” field 108 or both. If the user enters an e-mail address in field 106 and selects the “Send to Friend” button 102, the system first compares the address with e-mail addresses of registered users of the system. If it matches with an existing user, the selected contact(s) are sent to the recipient's Inbox and the system sends an e-mail to the recipient letting her know that she has received contacts in her Inbox from the sender. If it does not match with an existing user, the system sends an e-mail containing the contacts to the recipient's e-mail address letting him know that a user of the system has sent him contacts and that, when he signs up as a user of the system, these contacts will be accessible in his Inbox. If the user enters a phone number in field 108 and selects the “Send to Friend” button, the system first compares the number with phone numbers of registered users of the system. If it matches with an existing user, the selected contact(s) are sent to the recipient's contact list and the system uploads the contact(s) to the recipient's phone. If it does not match with an existing user, the system sends an SMS to the recipient's phone number letting him know that a user of the system has sent him contacts and that, when he signs up as a user of the system, these contacts will be accessible in his Inbox. If the user decides not to send contacts to a friend after entering screen 100, he may select the “Cancel” button 104 to return to the full listing of contacts.

FIG. 10 illustrates an exemplary graphical user web-interface 110 for displaying incoming contact information on the system, according to one embodiment of the present invention. An inbox screen 110 has a table 112 that lists contacts that have been sent to the user from other users, such as friends and family members. It is similar to the contacts table 72 in FIG. 7 but with the additional “From” field 114 that displays the name of the person who sent the contacts. The user has three options for handling the contacts in the Inbox after selecting them as discussed above for FIG. 7. The user can upload them to his phone by selecting the “Send to Mobile Phone” button 116. Once they have been sent to the phone as discussed above for FIG. 8, all selected contacts are also added to the user's contact list. After selecting the contacts, the user can instead select the “Add to contacts” button 118 to just transfer the selected contacts from the Inbox to the user's contact list. Lastly, the user can remove selected contacts from the Inbox list by selecting the “Remove” button 120.

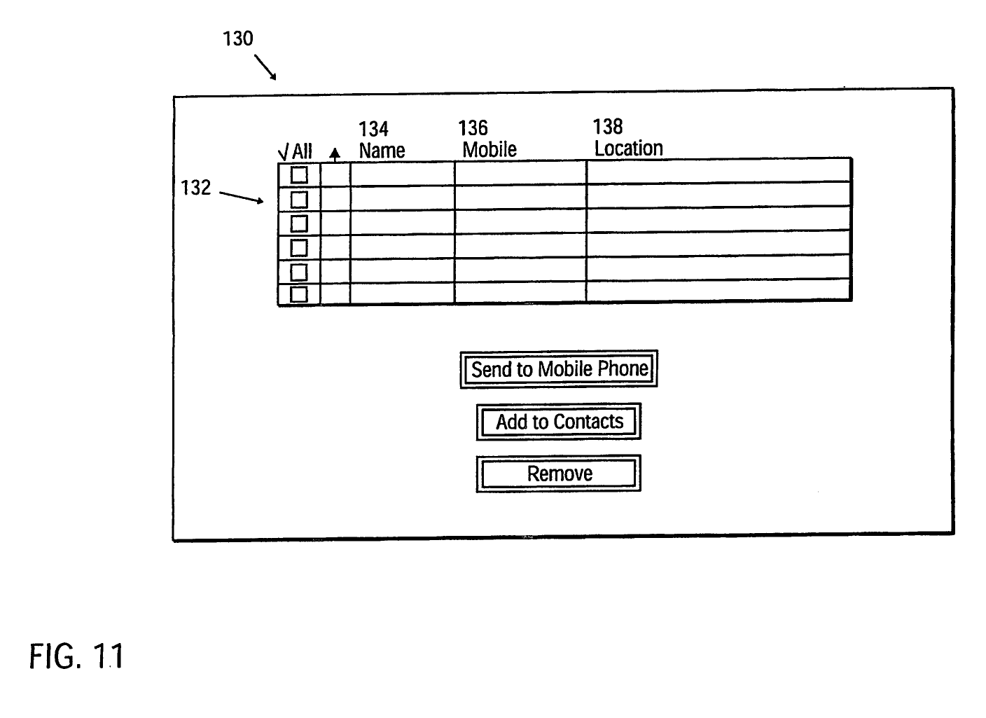

FIG. 11 illustrates an exemplary graphical user web-interface 130 for displaying business contact information on the system, according to one embodiment of the present invention. The table 132 is similar to the Inbox table but instead of multiple fields for phone numbers it provides just the single “Phone” field 136 and includes a new “Location” field 138. The Location field lists the street address, city and state of the business listed in the “Name” field 134. The listings in this screen, as provided by the system, are popular businesses located in the vicinity of the user as determined by the user's phone number. The user can choose the same actions for selected contacts as with the Inbox in FIG. 10: upload to phone; add to contacts list; or remove.

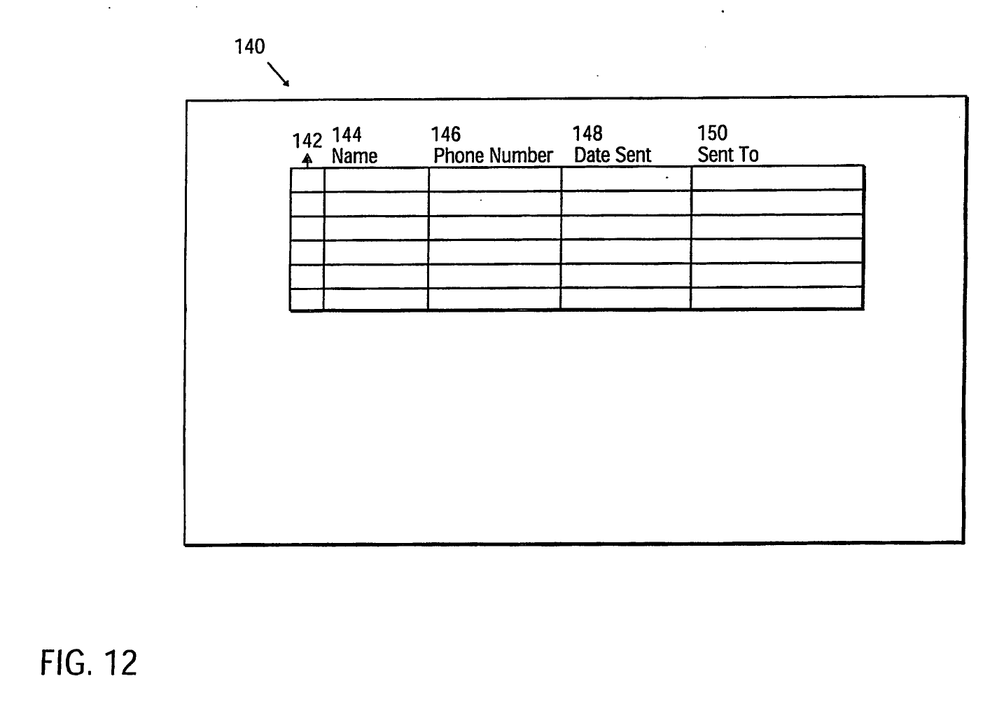

FIG. 12 illustrates an exemplary graphical user web-interface 140 for displaying system usage information, according to one embodiment of the present invention. Usage screen 140 includes table 142 that displays a log of contact information the user has uploaded to his phone. In addition to the name and phone number(s) that were uploaded, it shows the date and time of the upload in the “Date Sent” field 144 and the number of the phone to which the information was uploaded in the “Send To” field 146.

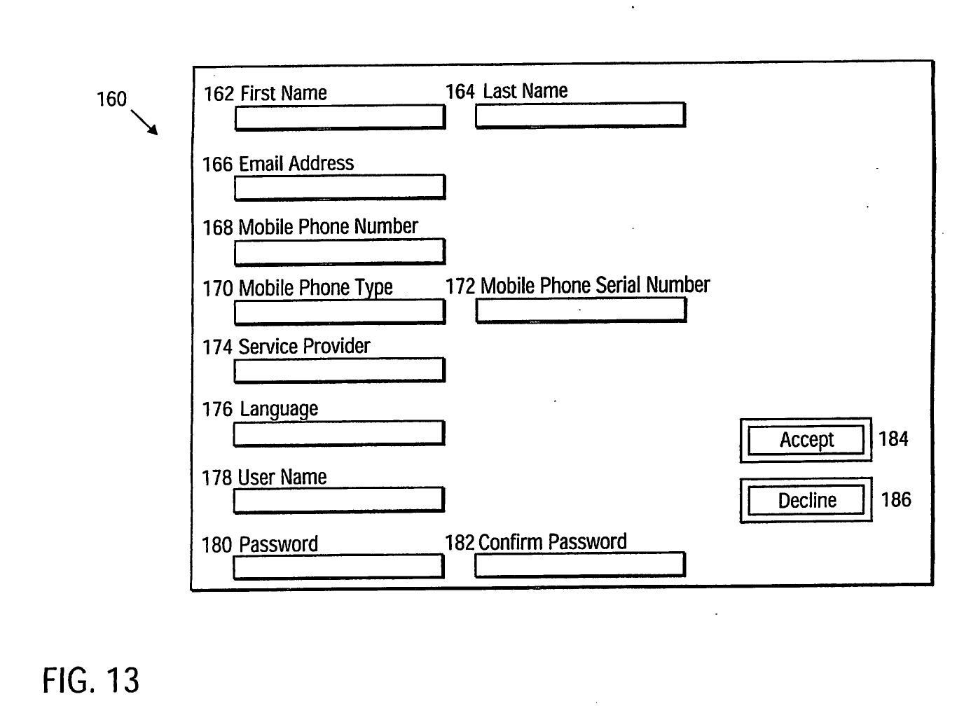

FIG. 13 illustrates an exemplary graphical user web-interface 160 for editing profile information on the system, according to one embodiment of the present invention. The profile screen 160 allows a user to edit any of the information listed in his profile except the mobile phone type 172. This includes first name 162, last name 164, e-mail address 166, mobile phone number 168, mobile phone serial number 170, service provider 174, language 176, user name 178, password 180 and password confirmation 182. The user then submits the updated profile information to the server by selecting the “Save Changes” button 184. The changes are not saved if the user instead clicks a different button in the system or goes to a new url on the Web.

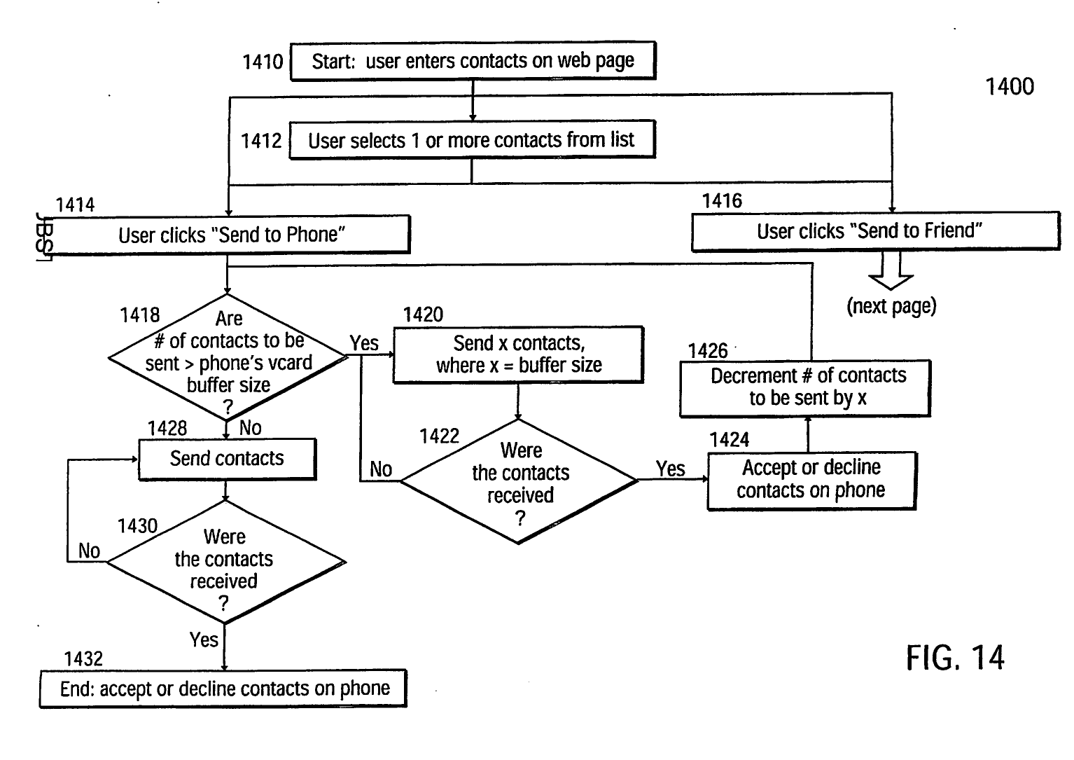

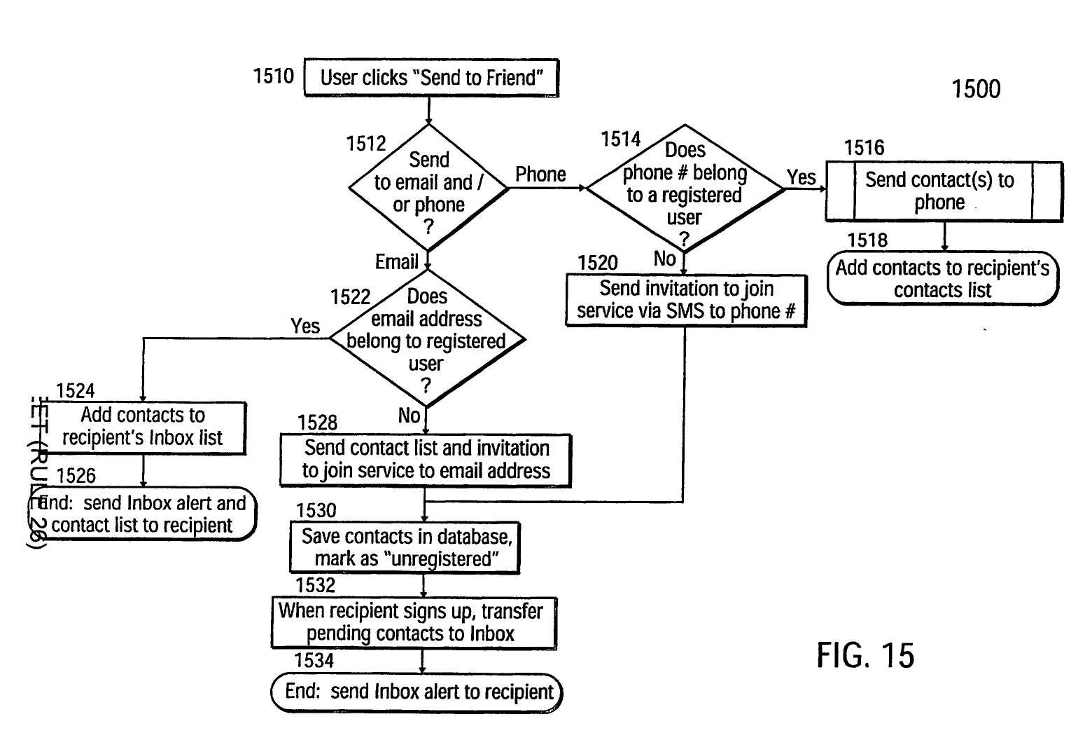

FIG. 14 illustrates an exemplary process 1400 for sending contacts from the web server to an SMS-enabled wireless device, according to one embodiment of the present invention. The process 1400 starts with the user entering contacts on the web page (box 1410) as described in FIG. 7. Then the user can either select 1 or more contacts from the list by clicking the corresponding check boxes (box 1412) and then click the button for the desired action, or can directly click the “Send to Phone” button (box 1414) or the “Send to Friend” button (box 1416). If the user does not select any contacts and chooses to directly select either of the buttons, all contacts are considered chosen. The remainder of the flowchart for the “Send to Friend” option is described below with reference to FIG. 15.

After selecting “Send to Phone”, the system checks (box 1418) to see if the number of contacts chosen is greater than the size of the phone's vcard buffer (the variable x is used to represent the size of a phone's vcard buffer). If so, the system sends x contacts to the phone (box 1420) and then displays a screen for the user to indicate if he has received the contacts on his phone (box 1422). If the user responds No, the system will re-send the contacts (box 1420) and then check again to confirm that the user has received them (box 1422). Once the user has received the contacts he can choose to accept them or not on his phone (box 1424).

After the user responds Yes that he has received the contacts (box 1422), the system decements the original number of contacts selected by x (box 1426) and then checks again (box 1418) to see if the the number of contacts chosen is greater than the size of the phone's vcard buffer. If so, the process above is repeated. If not, the remaining contacts are sent (box 1428). The system again displays a screen for the user to indicate if he has received the contacts on his phone (box 1430). If the user responds No, the system will re-send the contacts (box 1428) and then check again to confirm that the user has received them (box 1430). Once the user has received the contacts he can choose to accept them or not on his phone (box 1432). At this point, all of the selected contacts have been sent from the web to the phone.

FIG. 15 illustrates an exemplary process for sending contacts to additional SMS-enabled wireless devices, according to one embodiment of the present invention. This process 1500 can be continued from FIG. 14 after the user has selected contacts and then clicked the “Send to Friend” button (box 1510). The system then displays a screen for the user to enter an e-mail address and/or a phone number (box 1512); the user can do both.

If the user enters a phone number, the system first checks (box 1514) to see if that number belongs to a registered user of the system. If not, the system sends an invitation to join the system via an SMS message to that phone number (box 1520). The system then saves the contacts in the contact database, associates them with the specified phone number and marks them as “unregistered” (box 1530). When the recipient signs up for the system using that phone number, the saved contacts are transferred to the recipient's Inbox (box 1532). The system sends an Inbox alert e-mail to the recipient (box 1534) to inform him that he has contacts waiting in his Inbox.

If the phone number does belong to a registered user of the system, the system sends the selected contact(s) to the phone as described for FIG. 14, boxes 1418 to 1432. After all contacts have been sent, these contacts are added to the recipient's contacts list on the web.

If the user enters an e-mail address at step 1512, the system first checks (box 1522) to see if that e-mail address belongs to a registered user of the system. If not, the system sends the contact list and an invitation to join the system to that e-mail address (box 1528). The system then saves the contacts in the contact database, associates them with the specified e-mail address and marks them as “unregistered” (box 1530). When the recipient signs up for the system using that e-mail address, the saved contacts are transferred to the recipient's Inbox (box 1532). The system sends an Inbox alert e-mail to the recipient (box 1534) to inform him that he has contacts waiting in his Inbox.

If the e-mail address does belong to a registered user of the system, the system adds the contacts to the recipient's Inbox (box 1524). The system sends an Inbox alert e-mail to the recipient (box 1526) to inform him that the specified contacts are waiting in his Inbox.

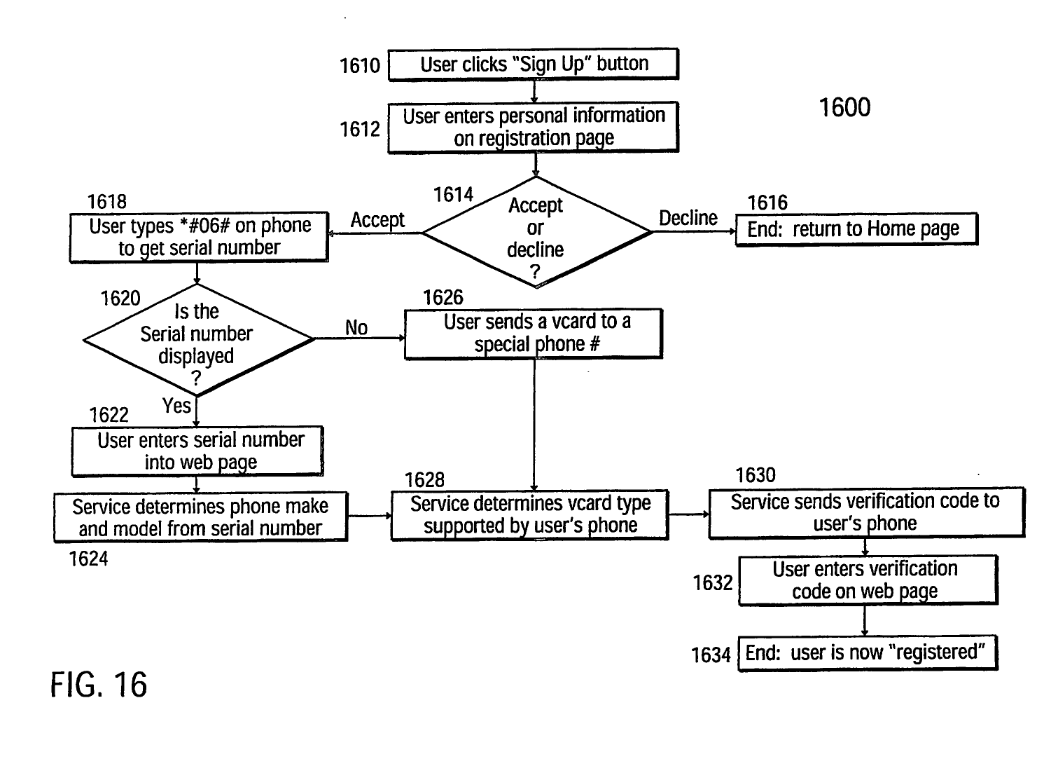

FIG. 16 illustrates an exemplary process for registering an SMS-enabled wireless device with the system, according to one embodiment of the present invention. The process 1600 allows a new user to sign-up with the system. First, the user clicks the “Sign Up” button on the home page (box 1610). The system displays the registration page (FIG. 6) where the user enters all the required personal information to register for the system (box 1612). Then the user may click either Accept or Decline (box 1614). If the user chooses Decline, the system returns to the home page (box 1616).

If the user chooses Accept, the system displays a page requesting the user type *#06# into his phone to get the serial number of the phone. Then the user enters the serial number on a web page (box 1618). If no serial number is displayed (box 1620), the system requests the user to send a vcard to a special phone number that the system monitors (box 1626). Upon receiving a vcard at this number, the system determines the specific type of vcard that was received and associates it with the sending phone number (box 1628). If the user does see a serial number displayed on his phone, he enters it in the appropriate box on the web page (box 1622). The system then uses this serial number to determine the phone make and model (box 1624) and, based on this information, the system can determine the specific type of vcard supported by the user's phone (box 1628).

The system then sends a special verification code to the user's phone (box 1630) and asks the user to enter this code on the web page (box 1632). This is a security step to ensure that the person registering does indeed have the phone associated with the phone number specified on the registration page. Once the system confirms that the verification code submitted by the user matches the one it has sent, the user is “registered”.

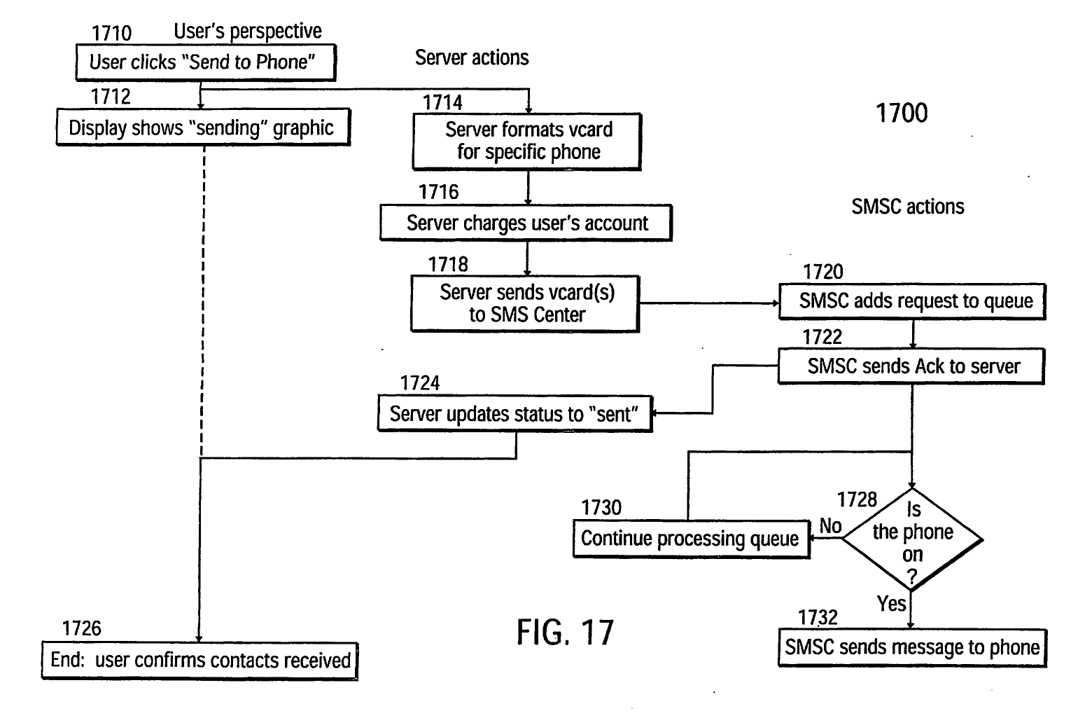

FIG. 17 illustrates an exemplary process for passing messages between an SMS-enabled wireless device and a web server, according to one embodiment of the present invention. Process 1700 shows the flow of messages between the phone and the server and gives a simplified view of the user's perspective. After the user clicks the “Send to Phone” button (box 1710), the system displays the “sending” graphic (box 1712), which for demonstrative purposes is a series of dots moving from left to right and back again until all contacts have been sent from the server.

At this point, the first action the server takes is to format the vcard(s) containing the contact(s) for the specific user's phone (box 1714). The server next charges the user's account (box 1716) for the specific monetary amount associated with sending the chosen number of contacts (as could be specified in a User Agreement), then sends the vcard(s) to the SMS Center (SMSC) (box 1718), which is a third-party server provided by a network operator for the purpose of sending phone SMS's. The SMSC adds this request to its queue of SMS requests (box 1720) and sends an acknowledgement (Ack) to the server (box 1722). Upon receiving the Ack, the server updates the status of the user's request to send contacts to his phone to “sent” (box 1724). The system then displays a screen for the user to indicate if he has received the contacts on his phone as shown in box 1422 of FIG. 14.

When the SMSC serviced this request from its queue, it first checks to see if the phone is powered on (box 1728); if not, it puts the request at the bottom of its queue and continues checking if the phone is powered on. Once it is, the SMSC sends the SMS to the phone (box 1732).

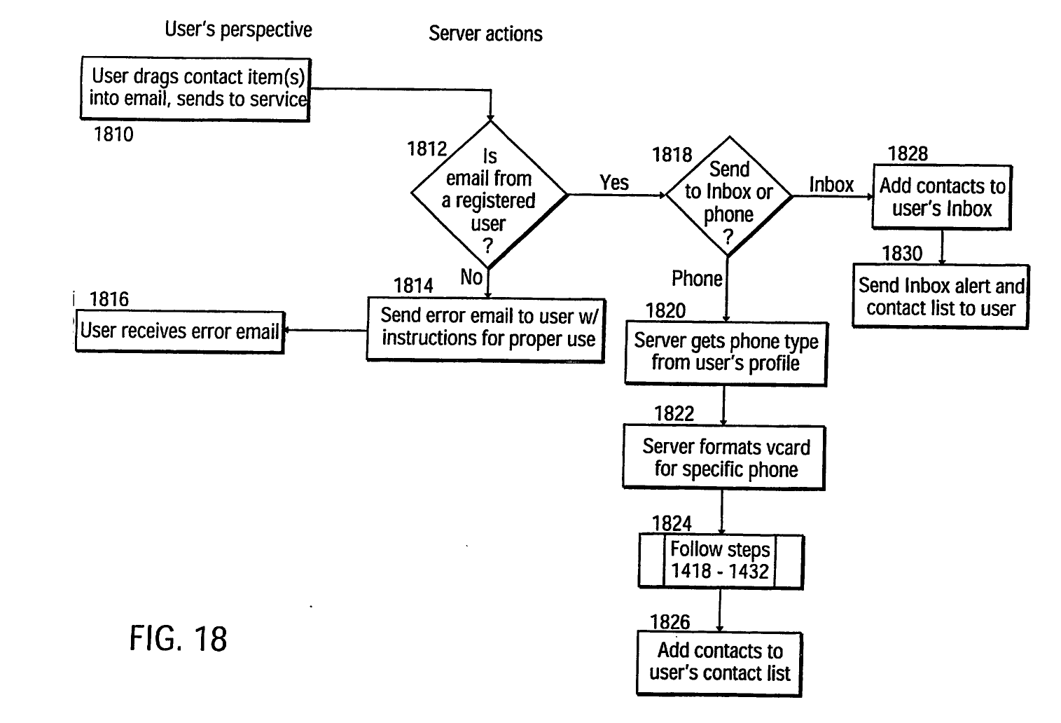

FIG. 18 illustrates an exemplary process for sending contacts via e-mail to a wireless device or web inbox, according to one embodiment of the present invention. Although described in connection with contacts, a similar process may be used for calendar items, where the term “contact” is replaced by “calendar item” and “vcard” is replaced by “vcalendar”. The process 1800 begins (box 1810) when a user enters contacts in an e-mail message, such as by dragging them from a contact list into the e-mail body (for example using an e-mail application such as MS Outlook™). The e-mail message arrives at the server (such as web server 161) and the server determines from the destination e-mail address that this is an e-mail containing contacts. The server checks first to see if the source e-mail address belongs to a registered user (box 1812). If not, the server sends an e-mail (box 1814) to the source e-mail address to inform the user (box 1816) how to use the service to send contacts to a wireless device or web inbox. The wireless device can be an SMS-enabled phone or a wireless device capable of receiving messages.

If the e-mail message is sent from an e-mail address registered with the server, the server determines if the contacts are to be sent to a wireless device or web inbox (box 1818). The server can determine this in multiple ways, such as from the user's web profile based on what the user has indicated, or from the destination e-mail address (eg, sendtophone@service.com or sendtoinbox@service.com), or from an indication in the subject or body of the e-mail. If the contacts are to be sent to the Inbox, the server adds them to the Inbox (box 1828) as described above in connection with FIG. 10 and then sends an Inbox alert e-mail to the recipient (box 1830) to inform him that the specified contacts are waiting in his Inbox.

If the contacts are to be sent to the user's phone, the server first gets the phone type from the user's profile (box 1820) and then formats the vcards that will contain the contact information appropriately for the specific wireless device (box 1822). These steps may be performed as described above in connection with FIG. 16. The server sends the contacts to the phone (box 1824) as described above in connection with FIG. 14, boxes 1418 to 1432. After all contacts have been sent, these contacts are added to the user's contact list stored on the web server (box 1826).

The foregoing embodiment described in connection with FIG. 18 is illustrative for an embodiment where the contacts enclosed in the email are stored in a vcard format. The following five formats specify additional exemplary embodiments for specifying contact information within the body of the email. In one embodiment, the subject line of the e-mail is ignored. However, in alternate embodiments, the subject line is also extracted and analyzed to determine if any of the pertinent information below is contained.

The first format is as follows:

1. A Basic Tagged Format.

To: <phone number, email address or user ID>
Name: <contact name>
Home: <contact's home phone number>
Mobile: <contact's mobile phone number>
Work: <contact's work phone number>

In one embodiment, the “To:” field is optional—such that if the “To:” field is missing from the text message, the server will automatically send the listed contact(s) to the member's wireless device. In order to avoid receiving an error message, the user should enter a value within the “Name” field and at least one phone number within the “phone number” field. In another embodiment of the basic tagged format, the user can enter more than one contact to be sent via email. When more than one contact is sent, the same format is used for the additional name(s) and number(s). For example, the body of the user's e-mail message could be:
To: 650-555-2938
Name: John Q Public
Home: 212-555-3849
Mobile: 203-555-4839
Work: 415-555-2937
Name: Jane R Public
Home: 390-555-2938
Work: 415-555-2938

The second format as is follows:

2. Ultra-Simple Format.

<contact name>
<phone number>

Here only one contact name and one phone number is entered. There is no need to enter prefixes, such as “To:” or “Home:.” The default procedure is for the server to send the contact to the user's own phone. The phone number entered in the “phone number” field will be considered to be the contact's mobile number. For example, the body of the user's e-mail message could be:
John Q. Public
301-555-3049

The third format is as follows:

3. Simple and Multiple.

<contact name>
<number>
<contact name>
<number>

With this format a user is enabled to easily create a long list of contact names and contact numbers quickly for upload to user's own phone in a single e-mail message. As above, there is no need to enter prefixes, such as “To:” or “Home:.” The default procedure is for the server to send the contact to the user's own phone. The phone number entered in the “phone number” field will be considered to be the contact's mobile number. For example, the body of the user's e-mail message could be:
John Q Public
212-555-3849
Jane R Public
390-555-2938

The fourth format is as follows:

4. Simple and Multiple with a Single Destination.

To: <number>
<contact name>
<number>
<contact name>
<number>

With this format a user is enabled to easily create a long list of contact names and contact numbers quickly in a single e-mail message for upload to a different wireless device than his/her own such as, a friend's wireless phone. There is one prefix used, the “To:” prefix. The default procedure is for the server to send the contacts to the phone number entered in the “To:” field. As above, the phone number entered in the “phone number” field will be considered to be the contact's mobile number. For example, with this format the body of the user's e-mail message could be:
To: 650-555-2938
John Q Public
212-555-3849
Jane R Public
390-555-2938

The fifth format is as follows:

5. Simple and Multiple with Multiple Destinations.

To:<number1>
<contact name>
<number>
To:<number2>
<contact name>
<number>
<contact name>
<number>
To:<number3>
<contact name>
<number>

With this format a user is enabled to easily create a long list of contact names and contact numbers quickly in a single e-mail message for upload to multiple different wireless devicea including his/her own such as, numerous friends' wireless phones. There is one prefix used before each contact name and number, the “To:” prefix. The default procedure is for the server to send the contacts to the unique phone number entered in the “To:” field. As above, the phone number entered in the “phone number” field will be considered to be the contact's mobile number. For example, with this format the body of the user's e-mail message could be:
To: 650-555-2938
John Q Public
212-555-3849
To: 650-555-3933
Jane R Public
390-555-2938

Although only these five formats were provided, numerous additional formats are supported. For example, the same contact information can be sent to numerous wireless devices by entering multiple phone numbers in the “To:” field. Additional combinations, of the use of prefixes in various formats is also contemplated.

Another embodiment of the present invention provides the ability for users to send text messages from a wireless device to a unique phone number so that the message is either saved by the service at the user's Web account (and optionally e-mailed to the user's e-mail address) or sent to an email address as specified in the text message. The user sends the text message to a unique phone number that the service receives and processes based on the content of the text message. If the first set of contiguous characters in the text message contain the “@” symbol, the service parses the e-mail address and sends the text following the email address to that address. If no email address is specified in the beginning of the text message, the service saves the text message in the user's account at the Web site and then checks the user's profile to determine if the user has also indicated that the message should be e-mailed to the user's e-mail address. If this option is indicated, the service sends the text to the user's email address.

One embodiment of the invention at a high level is a service providing several new capabilities to people who sign up as members of the system. The system enables a member to send contacts between a Web page and an SMS-enabled phone. The member is able to pace the uploading of contacts to the phone based on the vcard buffer size of the phone. A derivative of the system is the capability of the user to send contacts from the Web page contact list to another person based on the other person's phone number. Additionally, the system provides contact information of local businesses, which members can selectively upload to an SMS-enabled phone. Another aspect of the invention is the ability to determine the vcard type of a user's phone based on a vcard sent from that phone to the system.

In addition to the described mechanism to add contacts to the service and upload them to a phone, the service also supports the capability to upload contacts and calendar events to a phone from an e-mail sent by a user. E-mail is the most used application on the internet, so this mechanism provides an easy and ubiquitous method for members to add contacts to their contact list and send contacts and events to their phones. All the user does is send an e-mail with the contacts or events included in one of the supported formats (such as vcards and vcalendars from Microsoft Outlook's Contacts and Calendar listings) to a special address provided by the service (eg, addcontacts@vazu.com). Lastly, the service provides a mechanism for users to send text messages from a wireless device so that the message is either saved by the service and sent to the user's email address, or sent to a different e-mail address as specified at the beginning of the text message.

In the foregoing specification, the invention has been described with reference to specific embodiments. It will, however, be evident that various modifications and changes can be made without departing from the broader spirit and scope of the invention as set forth in the claims. The specification and drawings are, accordingly, to be regarded in an illustrative rather than a restrictive sense.

1. A method, comprising:
providing for one or more contacts to be included in an e-mail message addressed to a unique e-mail address;
receiving the e-mail message at a server associated with the unique e-mail address;
extracting the one or more contacts from the e-mail message;
determining a wireless device to send the one or more contacts to by extracting delivery data contained in the e-mail message;
generating one or more messages formatted specifically for the wireless device, wherein the one or more messages contain the one or more contacts;
checking if the wireless device is registered with the server; and
sending the one or more messages to the wireless device if the wireless device is registered with the server.

2. The method of claim 1, further comprising sending an error message to a user that sent the e-mail message, if the wireless device is not registered with the server.

3. The method of claim 1, further comprising sending an invitation message to the wireless device to register with the server.

4. The method of claim 1, further comprising adding the contacts received in the e-mail to a contact list stored on the server.

5. The method of claim 1, wherein the wireless device is an SMS-enabled wireless device.

6. The method of claim 1, wherein the delivery data includes a phone number, a recipient's e-mail address, a user ID, a sender's e-mail address.

7. The method of claim 6, wherein the delivery data is extracted from a subject section of the e-mail message.

8. The method of claim 6, wherein the delivery data is extracted from the body section of the e-mail message.

9. The method of claim 6, wherein the delivery data is extracted from a v-card tag within the e-mail message.

10. A method, comprising:
providing for one or more calendar events to be included in an e-mail message addressed to a unique e-mail address;
receiving the e-mail message at a server associated with the unique e-mail address;
extracting the one or more calendar events from the e-mail message;
determining a wireless device to send the one or more calendar events to by extracting delivery data contained in the e-mail message;
generating one or more messages formatted specifically for the wireless device, wherein the one or more messages contain the one or more calendar events;
checking if the wireless device is registered with the server; and
sending the one or more messages to the wireless device if the wireless device is registered with the server.

11. The method of claim 10, further comprising sending an error message to a user that sent the e-mail message, if the wireless device is not registered with the server.

12. The method of claim 10, further comprising sending an invitation message to the wireless device to register with the server.

13. The method of claim 10, further comprising adding the calendar events received in the e-mail to an events list stored on the server.

14. The method of claim 10, wherein the wireless device is an SMS-enabled wireless device.

15. The method of claim 10, wherein the delivery data includes a phone number, a recipient's e-mail address, a user ID, a sender's e-mail address.

16. The method of claim 15, wherein the delivery data is extracted from a subject section of the e-mail message.

17. The method of claim 15, wherein the delivery data is extracted from the body section of the e-mail message.

18. The method of claim 15, wherein the delivery data is extracted from a v-card tag within the e-mail message.

19. A method, comprising:
providing for a text message to be entered into a wireless device and sent to a unique phone number;
receiving the text message at a server; and
storing the text message in a user account on the web server associated with the wireless device.

20. The method of claim 19, further comprising:
determining an e-mail address to send the text message to from delivery data sent with the text message; and
sending the text message to the e-mail address if the wireless device is registered with the server.

21. The method of claim 20, wherein the delivery data includes a phone number of the wireless device and the e-mail address.

22. The method of claim 19, further comprising:
sending an error message to the wireless device if the wireless device is not registered with the server.

23. The method of claim 20, further comprising:
sending an invitation to the e-mail address, if the e-mail address is not registered with the server.

24. A method, comprising:
providing for one or more contacts to be selected via a web browser from a first contact list stored on a web server; and
sending the one or more contacts to an SMS-enabled wireless device if the wireless device is registered with the web server.

25. The method of claim 24, further comprising checking if the wireless device is registered on the web server and associated with the first contact list.

26. The method of claim 24, wherein the wireless device is registered on the web server and associated with a user.

27. The method of claim 24, further comprising:
synchronizing a second contact list stored on the wireless device with the first contact list with a single click of a button on a web browser.

28. The method of claim 24, further comprising:
storing profile information on the web server, including the first contact list, a user name, a vcard type associated with the wireless device, a phone number associated with the wireless device and an e-mail address.

29. The method of claim 28, wherein sending the one or more contacts, comprises sending one or more vcards associated with each of the one or more contacts from the web server to the wireless device.

30. The method of claim 24, further comprising sending the one or more contacts to a plurality of SMS-enabled devices.

31. The method of claim 24, further comprising:
saving the contacts on a database if the wireless device is not registered with the web server;
sending the contacts from the database to the wireless device once the wireless device is registered with the web server; and
adding the contacts to a second contact list on the web server associated with the wireless device once the wireless device is registered with the web server.

32. The method of claim 31, further comprising:
sending the wireless device an alert that the contacts have been received and will not be available unless the wireless device is registered with the web server; and
sending the wireless device an invitation to register with the web server if the wireless device is not registered with the web server.

33. The method of claim 31, further comprising:
sending an e-mail message to a user indicating the wireless device is not registered with the web server if the wireless device is not registered with the web server.

34. The method of claim 24, further comprising:
determining if a receive buffer in the wireless device has sufficient space to store the contacts;
sending some of the contacts to fill the receive buffer;
alerting the wireless device that the receive buffer is full; and
sending any remaining contacts of the contacts once the receive buffer has space.

35. The method of claim 24, further comprising sending multiple business contacts relating to a common category, wherein the common category includes restaurants, plumbers, and movie theaters.

36. The method of claim 24, further comprising:
determining a type of vcard sent by the wireless device; and
formatting the contacts to match the type of vcard used by the wireless device.

37. The method of claim 24, further comprising resending one or more unsent contacts of the one or more contacts that are not received by the wireless device.

38. A method, comprising:
receiving one or more contacts at a web server from an SMS-enabled wireless device having a first contact list; and
adding the one or more contacts to a second contact list on the web server.

39. The method of claim 38, wherein the wireless device is registered on the web server and associated with the contact list.

40. The method of claim 38, wherein the wireless device is registered on the web server and associated with a user.

41. The method of claim 38, further comprising:
synchronizing the first contact list stored on the wireless device with the second contact list with a single click of a button on a web browser.

42. The method of claim 38, wherein receiving the one or more contacts, comprises receiving at the web server one or more vcards associated with each of the one or more contacts from the wireless device.

43. The method of claim 38, further comprising:
storing profile information on the web server, including the second contact list, a user name, a vcard type associated with the wireless device, a phone number associated with the wireless device and an e-mail address.

44. The method of claim 43, further comprising matching a phone number of the wireless device with the profile information.

45. A method, comprising:
providing for one or more contacts to be selected via a web browser from a first contact list stored on a web server;
adding the contacts to a second contact list; and
sending the contacts to an SMS-enabled wireless device.

46. A method, comprising:
receiving a contact from a first wireless device;
storing the contact on a first contact list stored on a the web server;
storing the contact on a second contact list stored on the web server; and
sending the contact to a second SMS-enabled wireless device.
